(19) United States
(12) Patent Application Publication
(10) Pub. No.: US 2024/0173187 A1
(43) Pub. Date: May 30, 2024

(54) INCUBATOR

(71) Applicant: JW Pharmaceutical Corporation, Gwacheon-si (KR)

(72) Inventors: Dong-Soo JEONG, Incheon (KR); Baek-Ki HAM, Incheon (KR)

(21) Appl. No.: 18/283,711

(22) PCT Filed: Jul. 5, 2021
(86) PCT No.: PCT/KR2021/008471

§ 371 Date: Sep. 22, 2023

(30) Foreign Application Priority Data
Mar. 24, 2021 (WO) PCT/KR2021/003666

(51) Int. Cl. A61G 11/00

(52) U.S. Cl. CPC A61G 11/003

(57) ABSTRACT

Proposed is an incubator that comprises a body including a bottom plate to lay a baby on an upper portion, a fixed frame connected at a lower portion to a side of the body, an elevation frame connected to the fixed frame and configured to be moved up and down with respect to the fixed frame, a heater configured in conjunction with movement of the elevation frame and being moved up and down with up-down movement of the elevation frame, a hood connected to the elevation frame and configured to open and close a top of the body by moving up and down in conjunction with movement of the elevation frame, and a driving mechanism for moving up and down the elevation frame and the hood, and further comprises a tilting means of tilting the heater at a predetermined angle in conjunction with up-down movement of the elevation frame.

### CROSS-REFERENCE TO RELATED APPLICATIONS

This application is a National Stage of International Patent Application No. PCT/KR2021/008471, filed on Jul. 5, 2021, which claims priority to International Patent Application No. PCT/KR2021/003666, filed Mar. 24, 2021, the disclosures of which are incorporated by reference in their entireties.

### FIELD OF THE INVENTION

The present disclosure relates to an incubator including a heater and a hood.

### BACKGROUND OF THE INVENTION

An incubator is a device for isolating a premature baby or a newborn baby with a problem and keeping the baby warm. In general, an incubator for taking care of a premature baby is classified into a closed care type and an open care type, depending on whether it is possible to access the external environment. The closed care is generally called an incubator and provides a premature baby with temperature and humidity at predetermined levels using a hood installed around the premature baby, and the open care is generally called a warmer and makes it possible to maintain a premature baby at a predetermined temperature using radiation heat from a heater installed over the premature baby without the hood of such an incubator. Such incubator and warmer of the related art were separately manufactured. Accordingly, there was a problem that when it is required to change the closed care into the open care, a premature baby is moved to a separate warmer from an incubator, so the temperature condition around the premature baby may rapidly change and the premature baby may be exposed to infection due to the surrounding environment. In order to solve this problem, incubators that can be used as both a closed care type and an open care type are under development. Such incubators have a flat surface on which an infant sleeps and a guard surrounding the surface and generally have an overhead type radiation heater for keeping an infant warm at a predetermined temperature.

An incubator including a hood and a heater has been disclosed in Korean Patent No. 10-1314189 as a related art about incubators. However, such an incubator has a problem that since power for the heater is cut in a closed care, humidity is generated in an isolation chamber in an incubator mode, so it is difficult for a user to secure a visual field for checking the inside of the isolation chamber. Further, there is a problem that since the angle of the heater is fixed, the thermal efficiency may be deteriorated in conversion of a closed care and an open care.
(Patent Document 1) Korean Patent No. 10-1314189.

### Technical Problem

The present disclosure has been made in an effort to solve the problems in the related art and an objective of the present disclosure is to provide an incubator that not only provides an effect of minimizing a heat loss between a closed care and an open care by inclining a heater toward a body at a predetermined height with the heater and a hood both in operation, but also removes humidity around the body by driving the heater even in a closed care state.

### Technical Solution

The present disclosure provides an incubator that comprises: a body including a bottom plate to lay a baby on an upper portion; a fixed frame connected at a lower portion to a side of the body; an elevation frame connected to the fixed frame and configured to be moved up and down with respect to the fixed frame; a heater configured to be in conjunction with movement of the elevation frame and being moved up and down with up-down movement of the elevation frame; a hood connected to the elevation frame and configured to be able to open and close a top of the body by moving up and down in conjunction with movement of the elevation frame; and a driving mechanism for moving up and down the elevation frame and the hood, and further comprises a tilting means of tilting the heater at a predetermined angle in conjunction with up-down movement of the elevation frame. According to the present disclosure, since the heater is tilted toward the body at a predetermined height, it is possible to minimize a heat loss when changing a closed care and an open care into each other and it is possible to more efficiently transmit heat to the inside of the incubator in the open care.

Further, in a first aspect of the present disclosure, the tilting means comprises: a plurality of hinge shafts rotatably connecting the heater to the elevation frame through the fixed frame; and a tilting guide groove formed on a side of the fixed frame to guide up-down movement of the hinge shafts and tilting. According to the first aspect, since it is possible to achieve a configuration in which when the elevation frame is moved up and down, the heater is also moved up and down and tilted through a simple structure by adjusting the shape of the tilting guide groove for guiding up-down movement of the heater.

Further, in a second aspect of the present disclosure, the tilting guide groove comprises an elevation groove extending in a longitudinal direction of the fixed frame and a tilting groove extending at an angle from the elevation groove toward the body. By forming the tilting guide groove in the simple shape described above, it is possible to easily achieve tilting operation when the heater is moved up and down.

Further, in a third aspect of the present disclosure, the hood is connected to the elevation frame such that relative movement is possible, and an up-down movement speed of the hood is faster than an up-down movement speed of the elevation frame when the elevation frame and the hood are moved up. According to this configuration, it is possible to prevent a collision of the heater and the hood due to tilting of the heater when the heater and the hood are simultaneously moved up and down.

Further, according to a fourth aspect of the present disclosure, the elevation groove and the tilting groove of the tilting guide groove are configured such that when the elevation frame and the hood are moved up, the heater is tilted toward the body from a position at which a position of the hood becomes higher than a position of the heater. According to this configuration, it is possible to more effectively prevent a collision of the heater and the hood due to tilting of the heater when the heater and the hood are simultaneously moved up and down.

Further, according to a fifth aspect of the present disclosure, the heater is positioned at a first position at a side of the body in a closed care state in which the hood is closed, and the heater is positioned at a second position over the body at which a heat radiator of the heater is inclined toward the body in an open care state in which the hood is open. According to this configuration, since the heater is positioned at a side of the body in the closed care state, it is possible to perform a function of removing humidity around the body when operating the heater. Further, in the open care state, it is possible to make the environment in the body be suitable for a premature baby by heating the air in the body with the hood open.

Further, in the sixth aspect of the present disclosure, the heater is operated at a first temperature at the first position and is operated at a second temperature, which is higher than the first temperature, at the second position. When the heater is at the first position, the heater has only to be controlled at a temperature suitable for removing humidity, so it is not required to drive the heater at a high temperature like when the heater is at the second position. Accordingly, it is possible to reduce an energy loss by employing this structure.

Further, according to a seventh aspect of the present disclosure, the driving mechanism comprises: a driving source; a first screw shaft connected to the elevation frame; and a first nut mounted on the screw shaft in a threaded type, and the first nut and the first screw shaft are rotated relatively to each other by the driving source, whereby the first screw shaft is moved forward and backward and the elevation frame is moved up and down. According to this configuration, it is possible to efficiently move up and down the elevation frame through a simple power transmission structure.

Further, according to an eighth aspect of the present disclosure, the incubator further comprises a guide block connected to the hood and accommodated in the elevation frame, and the fixed frame and the elevation frame have a guide groove for guiding up-down movement of the guide block. According to this configuration, when the hood is moved up, the hood can be moved up to a position higher than a predetermined position of the fixed frame. Accordingly, it is possible to sufficiently secure a work space in the open care and it is possible to make the incubator compact in the closed care.

Further, in a ninth aspect of the present disclosure, the incubator further includes a second screw shaft of which a first end is connected to the guide block such that relative rotation is impossible and of which a second end is mounted in the first screw shaft in a threaded type, and as the first screw shaft is rotated, the second screw shaft is driven forward and backward by relative rotation of the first screw shaft and the second screw shaft, whereby the hood mounted on the guide block is moved up and down. According to this configuration, it is possible to link the up-down movement of the hood and the elevation frame through a simple power transmission structure.

Further, in a tenth aspect of the present disclosure, the heater is rotatably connected to the fixed frame, and the tilting means may rotate the heater between an upper side and a lower side in conjunction with up-down movement of the elevation frame. In this case, it is possible to move up and down the heater between an upper side and a lower side and tilt the heater at a predetermined angle by rotating the heater clockwise.

Further, in an eleventh aspect of the present disclosure, the tilting means comprises: a rotary block extending from the heater and including a curved movement guide groove configured to guide rotation movement of the heater; a rotation shaft formed on a side of the fixed frame and rotatably connecting the rotary block to the fixed frame; a conveying block moving up and down in conjunction with up-down movement of the elevation frame; and a movement guide shaft formed on a side of the conveying block and inserted in the movement guide groove, whereby it is possible to achieve the rotation movement according to the tenth aspect.

Further, in a twelfth aspect of the present disclosure, the elevation frame includes a driving block configured to move up and down as the elevation frame is moved up and down, and the incubator may comprise a guide shaft extending in an extension direction of the fixed frame, slidably connected to the fixed frame, and positioned between the conveying block and the driving block under the conveying block.

Further, in a thirteenth aspect of the present disclosure, the heater may be positioned at a third position at a side of the body at which a heat radiator of the heater faces in an opposite direction of the body in a closed care state in which the hood is closed, and the heater may be positioned at a fourth position over the body at which the heat radiator of the heater is inclined toward the body in an open care state in which the hood is open.

Further, in a fourteenth aspect of the present disclosure, the heater may stop operating at the third position and may be operated at a predetermined temperature at the fourth position.

Further, in a fifteenth aspect of the present disclosure, the incubator may comprise a plurality of position sensors, and the plurality of position sensors may sense a position of the driving block when the heater is at the third position and the fourth position.

Further, in a sixteenth aspect of the present disclosure, operation modes of the heater may be changed in accordance with a sensing result by the plurality of position sensors.

### Advantageous Effects

According to an incubator according to the present disclosure, when the closed care is changed into the open care, the heater is moved to an appropriate position almost simultaneously with opening of the body by linking the operation of the hood opening/closing the top of the body of the incubator and the tilting operation of the heater to each other through a driving mechanism, so the incubator can perform the function of a warmer. Accordingly, it is possible to prevent a rapid change of a temperature condition around a premature baby when changing the closed care into the open care. Further, since it is possible to close the body almost simultaneously with backward movement of the heater from a warmer posture when changing the open care into the closed care, it is possible to maximally prevent a premature baby from being exposed to infection due to the surrounding environment. Further, since the heater is moved down to a side of the body in the closed care, it is possible to make the entire incubator in a compact size.

Since the incubator of the present disclosure includes an automatic temperature controller that automatically controls the temperature of the heater when the closed care and the open care are changed into each other, it is possible to minimize a heat loss when changing modes. Further, since operation of the heater is maintained even in the closed care, it is possible to secure a visual field for a user to monitor the inside of the body by removing humidity around the body.

### BRIEF DESCRIPTION OF THE DRAWINGS

FIG. 1 is a side view showing an incubator according to an embodiment of the present disclosure in an open care state.

FIG. 2 is a front view showing the incubator according to an embodiment of the present disclosure in the open care state.

FIG. 3 is a side view showing the incubator according to an embodiment of the present disclosure in a closed care state.

FIG. 4 is a front view showing the incubator according to an embodiment of the present disclosure in the closed care state.

FIG. 5 is a front view showing a frame and an elevation frame according to an embodiment of the present disclosure.

FIG. 6 is a partial enlarged view showing the frame and the elevation frame according to an embodiment of the present disclosure.

FIG. 7 is a partial exploded perspective view showing an elevation structure for a hood and a heater according to an embodiment of the present disclosure.

FIG. 8 is a partial exploded perspective view of a rear part for showing a connection structure of the heater according to an embodiment of the present disclosure

FIG. 9 is a cross-sectional view showing the frame and the elevation frame according to an embodiment of the present disclosure.

FIG. 10 is a partial exploded perspective view of the rear part for showing the elevation structure for the hood and the heater according to an embodiment of the present disclosure.

FIG. 11 is a partial enlarged view showing an incubator according to another exemplary embodiment of the present disclosure in a closed care state.

FIG. 12 is a partial enlarged view showing the incubator according to another exemplary embodiment of the present disclosure in an open care state.

FIG. 13 is a partial enlarged view showing an elevation structure for a hood and a heater according to another exemplary embodiment of the present disclosure.

### DESCRIPTION OF REFERENCE NUMERALS

10: body
11: wheel
12: main column
13: trolley
20: base
21-1: left wall
21-2: right wall
22: head wall
23: foot wall
30: fixed frame
31: horizontal base member
32: guide groove
40: elevation frame
50: hood
51: hood connector
60: heater
61: heater connector
61a: heater fixing block
61b: heater hinge bracket
62a, 62b: hinge shaft
70: tilting guide
71: tilting guide groove
71a: elevation groove
71b: tilting groove
80: motor
81: first connection guide
82: second connection guide
83: first nut
84: first screw shaft
85: second screw shaft
86: hood guide block
100: rotary block
101: rotation shaft
102: movement guide groove
103: movement guide shaft
104: conveying block
105: guide shaft
106: driving block
107a: lower position sensor
107b: upper position sensor

### BEST MODE

### First Embodiment

Hereafter, a first exemplary embodiment of the present disclosure is described in detail through separate items of ^{┌}1. Schematic configuration of entire of incubator_{┐}, ^{┌}2. Configuration of fixed frame, elevation frame, and heater tilting structure_{┐}, and ^{┌}3. Operation of hood and heater_{┐}.

### 1. Schematic Configuration of Entire of Incubator

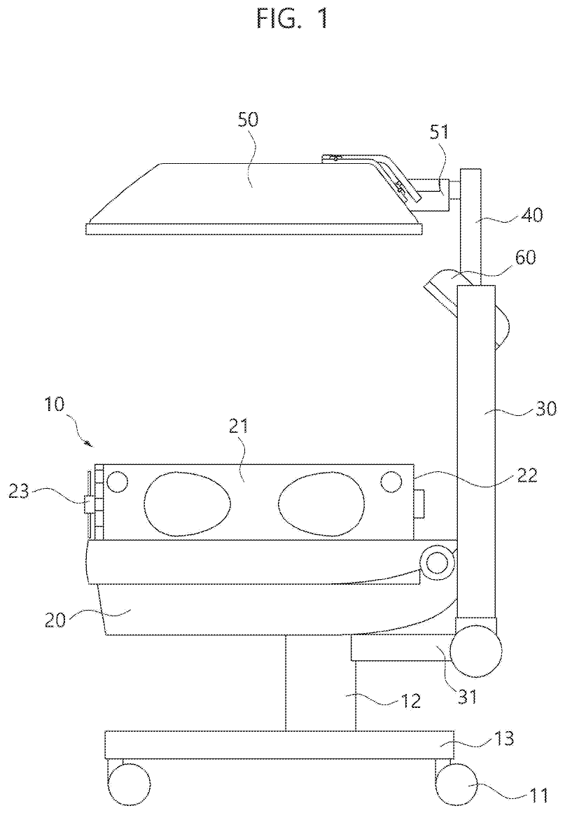

Hereafter, the basic structure of an incubator is described in detail with reference to FIGS. 1 to 4.

A body 10 of an incubator of the present disclosure, as shown in FIGS. 1 to 4, includes a trolley 13 having wheels 11 and a main column 12.

In detail, the wheels 11 are disposed under four corners of the trolley 13. The main column 12 is mounted on the trolley 13. Further, an incubator base 20 is installed on the main column 12. Further, a bottom plate including a flat container shape is installed on the incubator base 20. Further, a mattress on which a baby such as newborn baby can be laid may be disposed on the bottom plate. Further, a head wall 22 generally forming the wall at the head side of a baby, a foot wall 23 generally forming the wall at the leg side of a baby, a left wall 21-1 generally forming the wall at left side of a baby, and a right wall 21-2 generally forming the wall at the right side of a baby are installed to actually entirely form a rectangle on the incubator base 20.

Further, the walls may be formed by plastic forming that uses plastic such as polycarbonate resin and ABS resin as a material. Preferably, the walls may be made of a transparent material so that it is possible to observe the inside through the walls from the outside.

Further, a hood 50 that can open/close the top of the walls is disposed over the body 10. The hood 50 is connected to an elevation frame 40 to be described below through a hood connector 51 and a hood guide block 86, so the elevation frame 40 is moved up and down, the hood 50 can open and close the open top of the body 10. Accordingly, it is possible to change the care state of the incubator into an open care and a closed care. The hood 50 is not specifically limited as long as it can isolate the open top of the incubator from the external environment. The hood 50 may be made of a transparent material similarly to the walls so that a user can check the condition of a premature baby on the bottom plate in the body 10 in the closed care state.

Further, a heater 60 for adjusting the temperature of the space in which a premature baby is placed in the body 10 in the open care is provided. As will be described below, the heater 60 is configured to move between a standby position (first position) in the closed care and a warmer position (second position) in the open care by moving up and down as the elevation frame 40 is moved up and down. As will be described below, according to a first embodiment of the present disclosure, as the warmer position, the heater 60 is tilted such that a heat radiator thereof faces the inside of the body 10 to be able to more effectively adjust the temperature of the isolation space in the body 10. The heater 60 is not specifically limited as long as it is configured to apply heat toward the body 10, and preferably, may be a common far infrared ray radiation electric heater.

### 2. Configuration of Fixed Frame, Elevation Frame, and Heater Tilting Structure

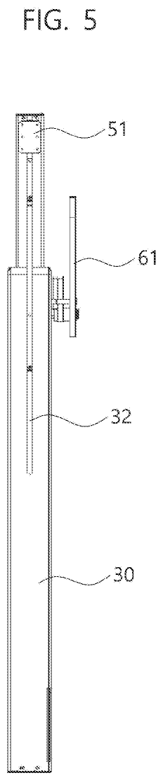

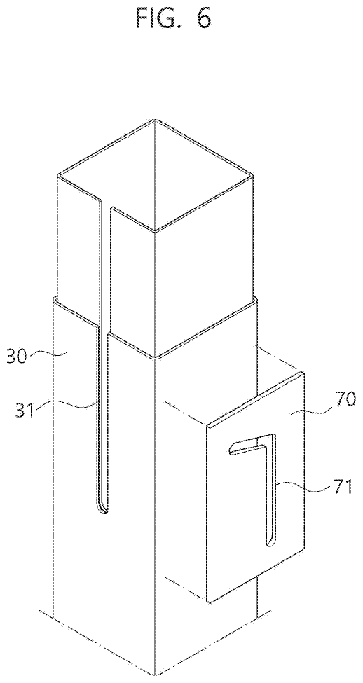

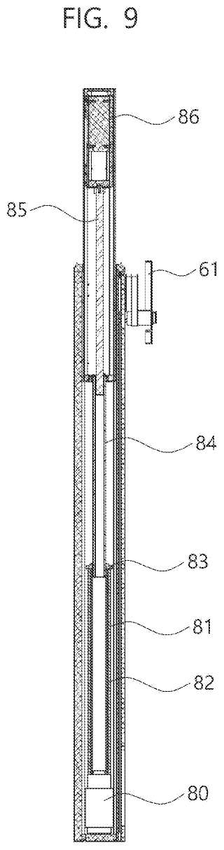

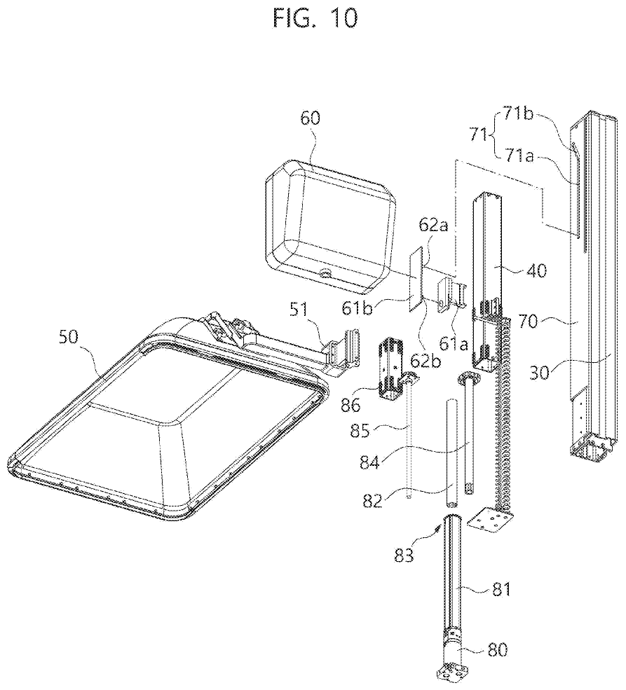

Hereafter, the fixed frame 30, the elevation frame 40, and a tilting structure for the heater 60 installed on the incubator are described in more detail with reference to FIGS. 5 to 10.

The fixed frame 30 that is a component of the incubator of the present disclosure, preferably, has a hollow polygonal cylindrical shape with an open top. Further, the fixed frame 30 is installed on a horizontal base member 31 disposed at a side of the body 10. In a preferred embodiment, two vertical fixed frames 30 may be disposed parallel to each other with a gap 10) therebetween to secure stability. However, only one, or three or more such members may be installed.

The elevation frame 40, preferably, has a hollow polygonal cylindrical shape similarly to the fixed frame 30. The elevation frame 40 is inserted in the internal space of the fixed frame 30. As shown in FIGS. 5 to 10, the elevation frame 30 is connected to the hood 50 and the heater 60 so that the heater 60 and the hood 50 are moved up and down in conjunction with up-down motion of the elevation frame 40. Further, a guide groove 32 that guides up-down movement of the hood guide block 86 connected to the hood connector 51 of the hood 50 is formed at the fixed frame 30 and the elevation frame 40. Further, the fixed frame 30 has a tilting guide 70 having a tilting guide groove 71 to be described below, thereby guiding tilting of the heater 60.

A motor 80 that is a power source for moving up and down the elevation frame 40 is disposed under the elevation frame 40. Over the motor 80, a first nut 83 is disposed in a fixed type and a first connection guide 81 having a hollow cylindrical shape is disposed in a rotation-impossible fixed type.

A second connection guide 82 of which a first end is connected to the output shaft of the motor 80 and that is accommodated in the first connection guide 81 is disposed in the first connection guide 81. A second end of the second connection guide 82 is connected to the lower end of a first screw shaft 84. Accordingly, when the output shaft of the motor 80 is rotated, the second connection guide 82 and the first screw shaft 84 are correspondingly rotated. Meanwhile, the first screw shaft 84 has a hollow circular cylindrical shape and threads are formed on both of the outer surface and the inner surface of the first screw shaft. Further, the upper end of the first screw shaft 84 is fixed in the elevation frame 40, and the outer surface having threads is thread-fastened to a first nut 83 of the first connection guide 81. As described above, since rotation movement of the first nut 83 of the first connection guide 81 is restricted, when the output shaft of the motor 80 is rotated, the first screw shaft 84 thread-fastened to the first nut 84 is axially straightly moved. Accordingly, the elevation frame 40 connected to the first screw shaft 84 can be moved up and down.

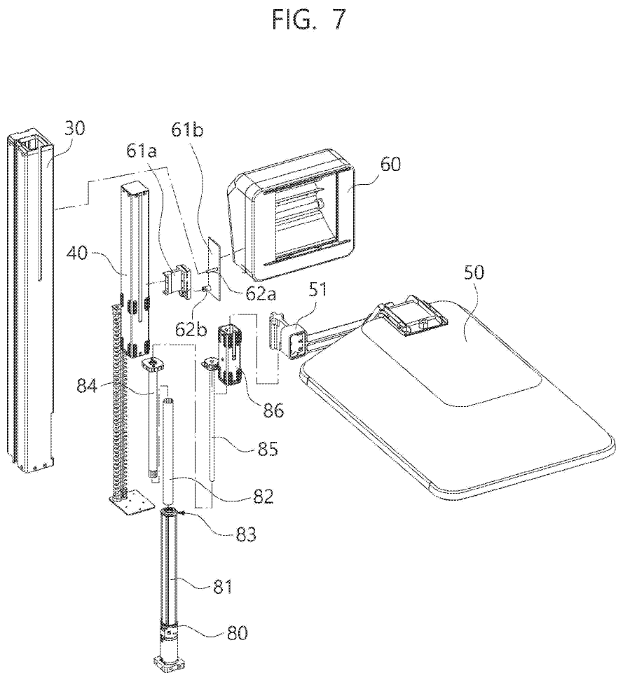

Meanwhile, a second screw shaft 85 is inserted in the first screw shaft 84. The upper end of the second screw shaft 85 is fixed to the hood guide block 86 for connecting the hood 50 to the elevation frame 40. Further, threads are formed on the outer surface of the second screw shaft 85 to be thread-fastened to the threads formed on the inner surface of the first screw shaft 84. Meanwhile, the hood guide block 86, as shown in FIG. 7, has a polygonal cross-section similarly to the elevation frame 40, so when the hood guide block 86 is accommodated in the elevation frame 40, it is accommodated in a rotation-impossible state. Accordingly, the second screw shaft 85 fixedly connected to the hood guide block 86 is also maintained in a rotation-impossible state in the elevation frame 40. Accordingly, since rotation of the second screw shaft 85 is restricted, when the first screw shaft 84 is rotated by rotation of the output shaft of the motor 80, the second screw shaft 85 is axially straightly moved. Accordingly, the hood 50 connected to the second screw shaft 85 can be moved up and down in conjunction with up-down movement of the elevation frame 40.

Meanwhile, it is possible to make the up-down movement speed of the elevation frame 40 and the up-down movement speed of the hood 50 different in accordance with rotation of the output shaft of the motor, which is a common power source, by appropriately limiting the shapes of the threads formed on the outer surface and the inner surface of the first screw shaft 84 and the threads formed on the outer surface of the second screw shaft 85. The up-down movement speed of the hood 50 may be faster than the up-down movement speed of the elevation frame 40 to prevent a collision of the heater 60 and the hood 50 due to tilting of the heater 60, which will be described below, when the heater 60 and the hood 50 are simultaneously moved up and down.

Meanwhile, the heater 60 is connected to the elevation frame 40 accommodated in the fixed frame 30 through a heater hinge bracket 61b and a heater fixing block 61a.

In more detail, the heater hinge bracket 61b is disposed on a first side of the heater 60. The heater hinge bracket 61b has two hinge shafts 62a and 62b protruding opposite to the heater 60, and one hinge shaft 62a of the hinge shafts is rotatably connected to the elevation frame 40 in the fixed frame 30 through the tilting guide groove 71 formed at the tilting guide 70 disposed on a side of the fixed frame 30. The other one hinge shaft 62b is rotatably connected to the heater fixing block 61a. The heater fixing block 61a is connected and fixed to the elevation frame 40 in the fixed frame through a groove formed on a side of the tilting guide 70 parallel to an elevation groove 71a of the tilting guide groove 71.

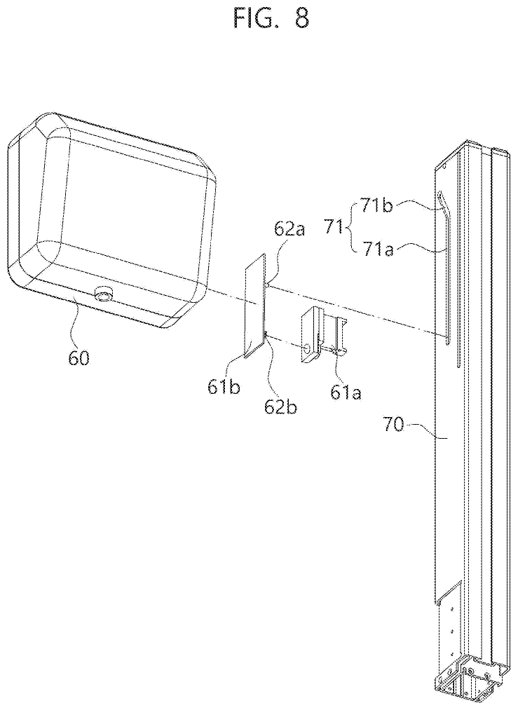

Meanwhile, as shown in FIG. 8, the tilting guide groove 71 is composed of the elevation groove 71a and a tilting groove 71b. The elevation groove 71a straightly extends in the up-down direction of the fixed frame 30 and the tilting groove 71b extends at an angle toward the body 10 from the elevation groove 71a. Accordingly, when the elevation frame 40 is moved up and the heater 60 is correspondingly moved up, the hinge shaft 62a directly rotatably connected to the elevation frame 40 is moved up longitudinally along the elevation groove 71a and then moved at an angle by the tilting groove 71b. The heater 60 is rotated on the hinge shaft 62b connected to the heater fixing block 61a by turn of the hinge shaft 62a, whereby the heater 60 is tilted toward the body 10.

Preferably, the elevation groove 71a and the tilting groove 71b of the tilting guide groove 71 are configured such that when the elevation frame 40 and the hood 50 are moved up, the heater 60 is tilted toward the body 10 from the position at which the position of the hood 50 become higher than the position of the heater 60. Accordingly, it is possible to more effectively prevent a collision of the heater 60 and the hood 50 due to tilting of the heater 60 when the heater 60 and the hood 50 are simultaneously moved up and down.

### 3. Operation of Hood and Heater

Hereafter, operation of the hood 50 and the heater 60 of the incubator according to the first preferred embodiment of the present disclosure is described in detail with reference to FIGS. 1 to 10.

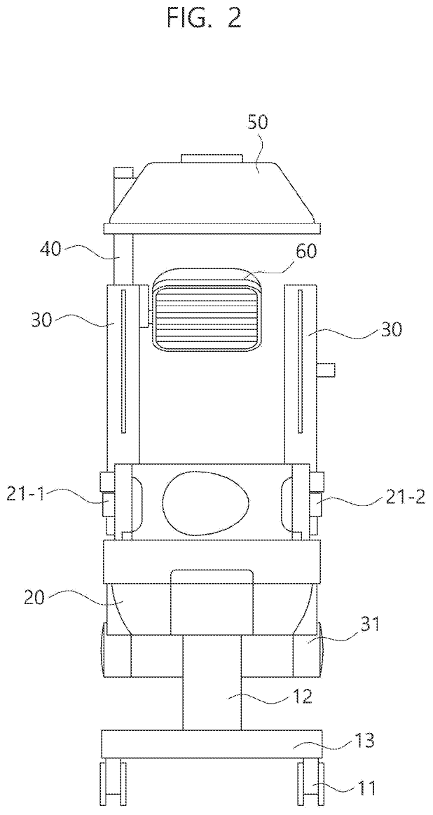

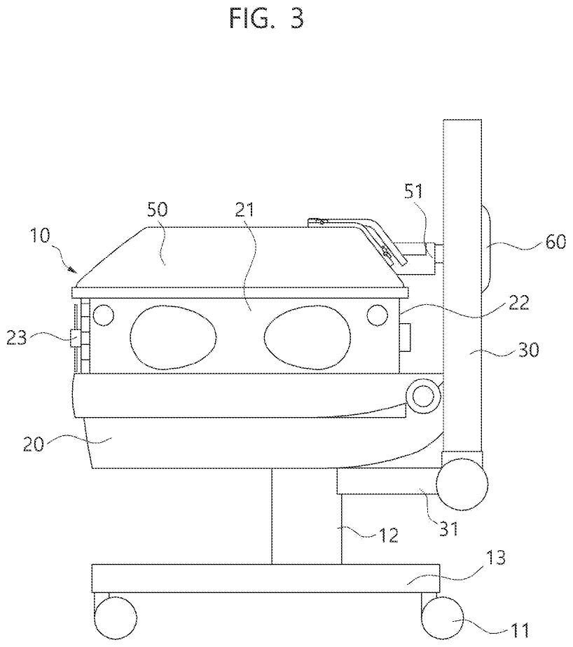

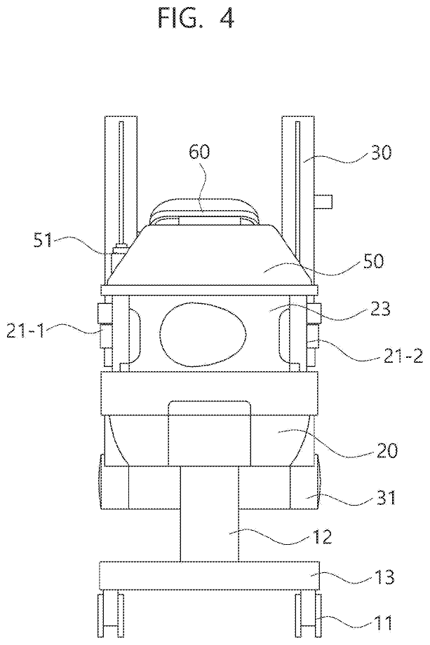

FIGS. 1 and 2 are views showing the incubator in the open care state and FIGS. 3 and 4 are views showing the incubator in the closed care state.

In the closed care state, the elevation frame 40 has been moved down to the lowermost position and is accommodated in the fixed frame 30. At this position, the hood 50 connected to the elevation frame 40 isolates the internal space of the body 10 by covering the open top of the body 10.

Meanwhile, in this state, the heater 60 is positioned at the first position at a side of the body 10. Accordingly, the heater 60 is operated at a first temperature at this position, thereby being able to remove humidity produced on the body 10 and the hood 50.

When an instruction to change into the open care state is input from a user through an external input device, etc., the motor 80 of the incubator starts to be driven. As the output shaft of the motor 80 is rotated, the second connection guide 82 connected to the output shaft and the first screw shaft 84 connected to the second connection guide 82 are rotated. The first screw shaft 84 is axially straightly moved by relative rotation of the first screw shaft 84 and the first nut 83, whereby the elevation frame 40 is also moved up. Accordingly, the heater 60 connected to the elevation frame 40 is also moved up. When the two hinge shafts 62a and 62b are moved along the elevation groove 71a, the heater 60 is moved in the up-down direction, but when the upper hinge shaft 62a starts to move along the tilting groove 71b, the heater 60 is tilted while rotating on the lower hinge shaft 62b. As described above, since the elevation groove 71a and the tilting groove 71b are configured such that when the elevation frame 40 and the hood 50 are moved up, the heater 60 is tilted toward the body 10 from the position at which the position of the hood 50 become higher than the position of the heater 60, the heater 60 is tilted under the hood 50.

Meanwhile, the second screw shaft 85 is also axially straightly moved in conjunction with the first screw shaft 84 by relative rotation of the first screw shaft 84 and the second screw shaft 85. Accordingly, the hood 50 mounted on the second screw shaft 85 is also moved by the hood connector 51 and the hood guide block 86. According to a preferred embodiment of the present disclosure, since the ascending speed of the hood 50 is faster than the ascending speed of the elevation frame 40 and heater 60 starts to be tilted after the height of the hood 50 becomes higher than the height of the heater 60, a collision of the heater 60 with the hood 50 due to tilting of the heater 60 does not occur when the hood 50 and the heater 60 are simultaneously moved up.

When reaching the second position (warmer position), the heater 60 is operated at a second temperature higher than the first temperature, thereby adjusting the temperature of the internal space of the body 10 with the hood 50 open.

FIGS. 1 and 2 show the incubator in the open care state by the operation described above.

As shown in FIGS. 1 and 2, the hood 50 has been moved up and the top of the body 10 of the incubator is open. Further, the heater 60 is positioned under the hood 50 and is positioned at the warmer position (second position) with the heat radiation side facing the inside of the body 10. When the hood 50 is at the second position, it functions as a general warmer. Therefore, according to the incubator of the present disclosure, the heater 60 is tilted toward a baby lying therein, whereby heat dissipation around the incubator is maximally prevented.

When an instruction to change into the closed care state is input from a user through an external input device, etc., in this open care state, the open care state is changed back into the closed state through a reverse process of the process described above. Meanwhile, in order for a user to easily monitor the inside of the body 10 by removing humidity of the body 10 after the open care is changed into the closed care, an automatic temperature controller may be provided so that the heater 60 can be operated even in the closed care. Further, preferably, the automatic temperature controller may be configured to sense the position of the heater 60 using a contact sensor, etc., which are not shown, and to automatically adjust the operation temperature of the heater 60 in accordance with the sensed position of the heater.

### Second Embodiment

Hereafter, a second embodiment of the present disclosure is described in detail with reference to the accompanying drawings. Meanwhile, the basic structure of the incubator according to the second embodiment is substantially the same as the basic structure of the incubator described in relation to the first embodiment. Accordingly, hereafter, the second embodiment is described through separate items of ^{┌}1. Configuration of fixed frame, elevation frame, and heater tilting structure_{┐} and ^{┌}2. Operation of hood and heater_{┐}, and the overlap structures with the first embodiment are not described in detail.

### 1. Configuration of Fixed Frame, Elevation Frame, and Heater Tilting Structure

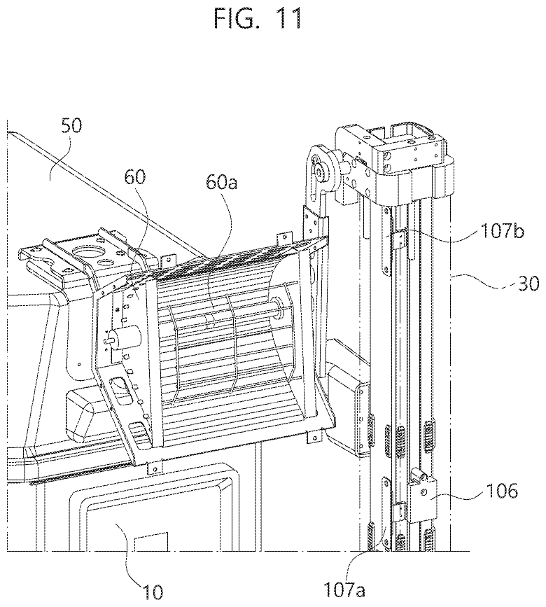

Hereafter, a fixed frame 30, an elevation frame 40, and a tilting structure for the heater 60 installed on the incubator according to the second embodiment are described in more detail with reference to FIGS. 11 to 13.

Similar to the first embodiment, the fixed frame 30, preferably, has a hollow polygonal cylindrical shape with an open top. Further, the fixed frame 30 is installed on a horizontal base member 31 disposed at a side of the body 10. More preferably, two vertical fixed frames 30 may be disposed parallel to each other with a gap therebetween to secure stability. However, only one, or three or more such members may be installed.

The elevation frame 40, preferably, has a hollow polygonal cylindrical shape similarly to the fixed frame 30. The elevation frame 40 is inserted in the internal space of the fixed frame 30. A motor 80 that is a power source for moving up and down the elevation frame 40 is disposed under the elevation frame 40. Meanwhile, the same structure as that described above in the first embodiment may be applied for the power source and the power transmission structure for moving up and down the elevation frame 40, so it is not described in detail.

A hood 50 is integrally connected to the upper portion of the elevation frame 40 through a hood connector 51. Accordingly, when the elevation frame 40 is moved up and down, the hood 50 is moved up and down in conjunction with the elevation frame 40.

Further, a driving block 106 that is moved up and down in conjunction with up-down movement of the elevation frame 40 is disposed under the elevation frame 40. The driving block 106 may be integrally formed with the elevation frame 40. In this case, the driving block 106 is integrally moved with the elevation frame from the beginning. Alternatively, the driving block 106 may be connected to be able to slide within a predetermined range with respect to the elevation frame 40. In this case, the driving block 106 is stopped until the elevation frame 40 is moved up 10) to a predetermined height, and the driving block 106 is integrally moved with the elevation frame 40 when the elevation frame 40 is moved up over the predetermined height. Accordingly, when the range of relative movement of the driving block 106 and the elevation frame 40 is adjusted, it is possible to control the driving timing between the hood 50 that is moved up and down in conjunction with the elevation frame 40 and the heater 60 that is moved up and down in conjunction with the driving block 106 which will be described below.

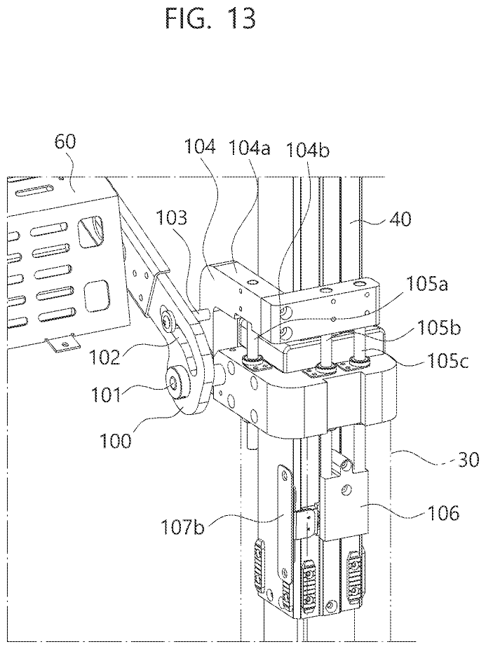

A conveying block 104 is disposed over the driving block 106. As shown in FIG. 13, preferably, the conveying block 104 may be formed in a shape surrounding the outer side of the fixed frame 30, and in this case, a plurality of conveying blocks 104a and 104b facing the sides of the fixed frame 30, respectively, may be connected. A movement guide shaft 103 protrudes from a side of the conveying block 104 and is connected to a rotary block 100 to be described below.

Guide shafts 105a and 105b are disposed between the driving block 106 and the conveying block 104. A plurality of guide shafts 105a, 105b, and 105c may be provided, as shown in FIG. 13, to secure stable driving. In the example shown in FIG. 13, the guide shafts 105a, 105b, and 105c are integrally formed with the bottom of the conveying block 104, but this embodiment is not limited thereto and they may be integrally formed with the top of the driving block 106. When the guide shafts 105a, 105b, and 105c are integrally formed with the bottom of the conveying block 104, as in the example shown in FIG. 13, as the driving block 106 is moved up, the driving block 106 comes in contact with the guide shafts 105a, 105b, and 105c integrally formed with the bottom of the conveying block 104. In this state, when the driving block 106 is further moved up, the driving block 106 pushes up the conveying block 104 through the guide shafts 105a, 105b, and 105c.

Meanwhile, the heater 60 is rotatably connected to the fixed frame 30 through the rotary block 100 extending rearward from a side or both sides of the heater 60.

The rotary block 100 is connected to be rotatable on a rotation shaft 101 protruding and extending from a side of the fixed frame 30. Further, a movement guide groove 102 curved around the rotary shaft 101 is formed at the rotary block 100. A movement guide shaft 103 of the conveying block 104 is inserted in the movement guide groove 102. Meanwhile, when the conveying block 104 is moved up and down in conjunction with up-down movement of the elevation frame 40, the movement guide shaft 103 is also moved up and down. Accordingly, when the movement guide shaft 103 is moved up and down, the movement guide groove 102 is moved on the movement guide shaft 103, whereby the rotary block 100 is forcibly rotated clockwise on the rotation shaft 101.

An upper position sensor 107b and a lower position sensor 107a are disposed at the upper portion and the lower portion of the fixed frame 30, respectively. The lower position sensor 107a and the upper position sensor 107b sense existence and movement of the driving block 106 at the positions.

### 2. Operation of Hood and Heater

Hereafter, operation of the hood 50 and the heater 60 of the incubator according to the second preferred embodiment of the present disclosure is described in detail with reference to FIGS. 11 to 13.

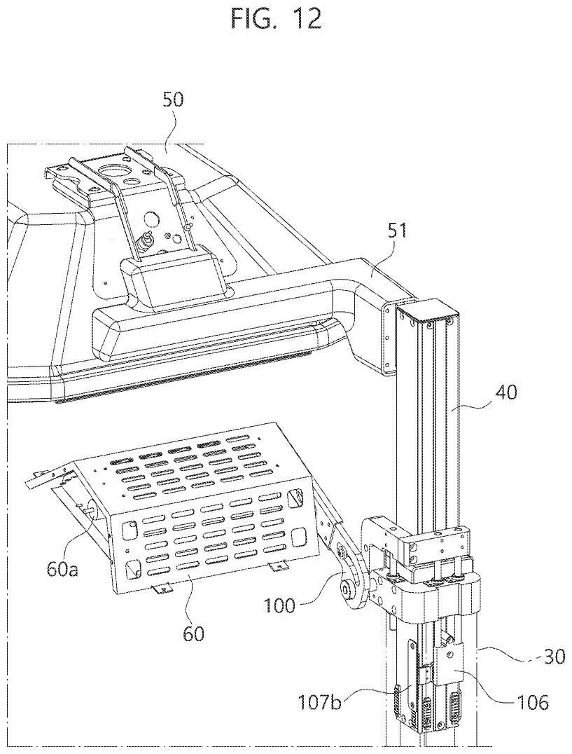

FIG. 11 is a view showing the incubator in the closed care state and FIG. 12 is a view showing the incubator in the open care state.

In the closed care state, the elevation frame 40 has been moved down to the lowermost position and is accommodated in the fixed frame 30. At this position, the hood 50 connected to the elevation frame 40 isolates the internal space of the body 10 by covering the open top of the body 10.

Meanwhile, in this state, the heater 60 is positioned at a third position at a side of the body 10. Further, a heat radiator 60a of the heater 60 faces the opposite direction of the body 10. Accordingly, preferably, the heater 60 may be turned off at the third position to prevent a user from being injured by heat of the heater 60. Further, at this position, the driving block 106 is at a position facing the lower position sensor 107a, so the lower position sensor 107a senses whether the driving block 106 exists, whereby it is possible to sense that the incubator is in the closed care state. Meanwhile, the heater 60 may be positioned higher than the open top of the body 10 at the third position so that the heater 60 does not interfere with the body 10 when rotating.

When an instruction to change into the open care state is input from a user through an external input device, etc., the motor 80 of the incubator starts to be driven. As the motor 80 is driven, as described in the first embodiment, the elevation frame 40 is moved up and the hood 50 connected to the elevation frame 40 is also moved up, whereby the open top of the body 10 is opened. Meanwhile, when the elevation frame 40 is moved up, as described above, the driving block 106 is also moved up in conjunction with the elevation frame 40. In this case, the lower position sensor 107a senses that the driving block 106 has started to move, whereby it is possible to sense that the closed care has started to be changed into the open care. Further, as the driving block 106 is moved up, the driving block 106 comes in contact with the lower ends of the guide shafts 105a, 105b, and 105c connected to the conveying block 104, and, after the upper end of the driving block 106 comes in contact with the lower ends of the guide shafts 105a, 105b, and 105c, the driving block 106 is further moved up with elevation of the elevation frame 40, so the conveying block 104 is also pushed up.

Further, when the conveying block 104 is moved up and down in conjunction with up-down movement of the elevation frame 40, the movement guide shaft 103 is also moved up and down. Accordingly, when the movement guide shaft 103 is moved up and down, the movement guide groove 102 is moved on the movement guide shaft 103, whereby the rotary block 100 is forcibly rotated clockwise on the rotation shaft 101.

Meanwhile, the elevation timing of the hood 50 and the rotation timing of the heater 60 may be appropriately controlled to prevent interference of the hood 50 and the heater 60 with each other when the closed care state is changed into the open care. It is possible to control the elevation timing of the hood 50 and the rotation timing of the heater 60 by adjusting the range of relative movement of the driving block 106 and the elevation frame 40, as described above.

Meanwhile, when the elevation frame 40 reaches an uppermost position, the heater 60 reaches a fourth position, and in this case, the heat radiator 60a of the heater 60 is inclined downward toward the body 10. Further, when the heater 60 reaches the fourth position, the heat radiator 60a is operated at a predetermined temperature, whereby the internal space of the body 10 with the hood 50 open is adjusted. Further, at the fourth position, the driving block 106 is at a position facing the upper position sensor 107b, so the upper position sensor 107b senses whether the driving block 106 exists, whereby it is possible to sense that the incubator is in the open care state. Accordingly, the heater 60 may be controlled to be immediately operated at a predetermined temperature when the upper position sensor 107b senses existence of the driving block 106.

FIG. 12 shows the incubator in the open care state by the operation described above. As shown in FIG. 12, the hood 50 has been moved up and the top of the body 10 of the incubator is open. Further, the heater 60 is positioned under the hood 50 and is positioned at the warmer position (fourth position) with the heat radiation side facing the inside of the body 10. Therefore, according to the incubator of the present disclosure, the heater 60 is tilted toward a baby lying therein, whereby heat dissipation around the incubator is maximally prevented.

When an instruction to change into the closed care state is input from a user through an external input device, etc., in this open care state, the open care state is changed back into the closed state through a reverse process of the process described above.

That is, there is a difference in that, in the first embodiment described above, when the elevation frame 40 is moved up and down, the heater 60 is also moved up and down because the elevation frame 40 and the heater 60 are directly connected, but, in the second embodiment, when the elevation frame 40 is moved up and down, the heater 60 is moved up and down by rotating on a predetermined rotation shaft. However, similar to the first embodiment, the second embodiment also has the same operation effect as the first embodiment in that as the elevation frame 40 is moved up and down, the hood 50 is also moved up and down and the heater 60 is also moved up and down and tilted.

### Mode for Invention

According to an incubator according to the present disclosure, when the closed care is changed into the open care, the heater is moved to an appropriate position almost simultaneously with opening of the body by linking the operation of the hood opening/closing the top of the body of the incubator and the tilting operation of the heater to each other through a driving mechanism, so the incubator can perform the function of a warmer. Accordingly, it is possible to prevent a rapid change of a temperature condition around a premature baby when changing the closed care into the open care. Further, since it is possible to close the body almost simultaneously with backward movement of the heater from a warmer posture when changing the open care into the closed care, it is possible to maximally prevent a premature baby from being exposed to infection due to the surrounding environment. Further, since the heater is moved down to a side of the body in the closed care, it is possible to make the entire incubator in a compact size.

### INDUSTRIAL APPLICABILITY

Since the incubator of the present disclosure includes an automatic temperature controller that automatically controls the temperature of the heater when the closed care and the open care are changed into each other, it is possible to minimize heat loss when changing modes. Further, since operation of the heater is maintained even in the closed care, it is possible to secure a visual field for a user to monitor the inside of the body by removing humidity around the body.

1. An incubator comprising:
a body including a bottom plate to lay a baby on an upper portion;
a fixed frame connected at a lower portion to a side of the body;
an elevation frame connected to the fixed frame and configured to be moved up and down with respect to the fixed frame;
a heater configured to be in conjunction with movement of the elevation frame and being moved up and down with up-down movement of the elevation frame;
a hood connected to the elevation frame and configured to be able to open and close a top of the body by moving up and down in conjunction with movement of the elevation frame;
a driving mechanism for moving up and down the elevation frame and the hood; and
a tilting means of tilting the heater at a predetermined angle in conjunction with up-down movement of the elevation frame.

2. The incubator of claim 1, wherein the tilting means comprises:
a plurality of hinge shafts rotatably connecting the heater to the elevation frame through the fixed frame; and
a tilting guide groove formed on a side of the fixed frame to guide up-down movement of the hinge shafts and tilting.

3. The incubator of claim 2, wherein the tilting guide groove comprises an elevation groove extending in a longitudinal direction of the fixed frame and a tilting groove extending at an angle from the elevation groove toward the body.

4. The incubator of claim 3, wherein the elevation groove and the tilting groove of the tilting guide groove are configured such that when the elevation frame and the hood are moved up, the heater is tilted toward the body from a position at which a position of the hood becomes higher than a position of the heater.

5. The incubator of claim 1, wherein the hood is connected to the elevation frame such that relative movement is possible, and an up-down movement speed of the hood is faster than an up-down movement speed of the elevation frame when the elevation frame and the hood are moved up.

6. The incubator of claim 1, wherein the heater is positioned at a first position at a side of the body in a closed care state in which the hood is closed, and the heater is positioned at a second position over the body at which a heat radiator of the heater is inclined toward the body in an open care state in which the hood is open.

7. The incubator of claim 6, wherein the heater is operated at a first temperature at the first position and is operated at a second temperature, which is higher than the first temperature, at the second position.

8. The incubator of claim 1, wherein the driving mechanism comprises:
a driving source;
a first screw shaft connected to the elevation frame; and
a first nut mounted on the screw shaft in a threaded type, and
the first nut and the first screw shaft are rotated relatively to each other by the driving source, whereby the first screw shaft is moved forward and backward and the elevation frame is moved up and down.

9. The incubator of claim 8, further comprising a guide block connected to the hood and accommodated in the elevation frame,
wherein the fixed frame and the elevation frame have a guide groove for guiding up-down movement of the guide block,
the incubator further includes a second screw shaft of which a first end is connected to the guide block such that relative rotation is impossible and of which a second end is mounted in the first screw shaft in a threaded type, and
as the first screw shaft is rotated, the second screw shaft is driven forward and backward by relative rotation of the first screw shaft and the second screw shaft, whereby the hood mounted on the guide block is moved up and down.

10. The incubator of claim 1, wherein the heater is rotatably connected to the fixed frame, and
the tilting means rotates the heater between an upper side and a lower side in conjunction with up-down movement of the elevation frame.

11. The incubator of claim 10, wherein the tilting means comprises:
a rotary block extending from the heater and including a curved movement guide groove configured to guide rotation movement of the heater;
a rotation shaft formed on a side of the fixed frame and rotatably connecting the rotary block to the fixed frame;
a conveying block moving up and down in conjunction with up-down movement of the elevation frame; and
a movement guide shaft formed on a side of the conveying block and inserted in the movement guide groove.

12. The incubator of claim 11, wherein the elevation frame includes a driving block configured to move up and down as the elevation frame is moved up and down, and
the incubator comprises a guide shaft extending in an extension direction of the fixed frame, slidably connected to the fixed frame, and positioned between the conveying block and the driving block under the conveying block.

13. The incubator of claim 12, wherein the heater is positioned at a third position at a side of the body at which a heat radiator of the heater faces in an opposite direction of the body in a closed care state in which the hood is closed, and the heater is positioned at a fourth position over the body at which the heat radiator of the heater is inclined toward the body in an open care state in which the hood is open.

14. The incubator of claim 13, wherein the heater stops operating at the third position and is operated at a predetermined temperature at the fourth position.

15. The incubator of claim 13, comprising a plurality of position sensors,
wherein the plurality of position sensors senses a position of the driving block when the heater is at the third position and the fourth position.

16. The incubator of claim 15, wherein operation modes of the heater are changed in accordance with a sensing result by the plurality of position sensors.
